(19) United States
(12) Patent Application Publication
(10) Pub. No.: US 2018/0118513 A1
(43) Pub. Date: May 3, 2018

(54) MONITORING SYSTEM FOR ELEVATOR SYSTEM TO ENSURE PREDETERMINED ELEVATOR SHAFT CLEARANCE

(71) Applicant: OTIS ELEVATOR COMPANY, FARMINGTON, CT (US)

(72) Inventors: Aurélien Fauconnet, Isdes (FR); Pascal Rebillard, Gien (FR); Franck Dominguez, Loiret (FR); Frédéric Beauchaud, Coullons (FR); Frédéric Grimault, Ouzouer Sur Loire (FR)

(21) Appl. No.: 15/569,685

(22) PCT Filed: Apr. 28, 2015
(86) PCT No.: PCT/IB2015/000842

§ 371 Date: Oct. 26, 2017

(51) Int. Cl. B66B 5/00

(52) U.S. Cl. CPC B66B 5/0031; B66B 5/0025; B66B 5/0068

(57) ABSTRACT

A monitoring system for an elevator system to ensure a predetermined elevator shaft clearance is provided and includes an elevator car moveably disposed in an elevator shaft and guided along at least one guide rail, the elevator shaft having a top surface and a bottom surface. Also included is a counterweight moveably disposed in the elevator shaft. Further included is a position monitoring device monitoring a position of at least one of the elevator car and the counterweight relative to at least one of the top surface and the bottom surface. Yet further included is a braking device actuated to initiate a braking event in response to detection of the position of at least one of the elevator car and the counterweight being within a predetermined distance from one of the top surface and the bottom surface.

### BACKGROUND OF THE INVENTION

The embodiments herein relate to elevator systems and, more particularly, to a monitoring system for an elevator system to ensure a predetermined elevator shaft clearance and safety volume.

Elevator systems include an elevator car, a counterweight, a suspension member (e.g., rope, belt, cable, etc.) that connects the hoisted structure and the counterweight. Such systems often include a car and/or counterweight buffer assembly located at the bottom of an elevator shaft to ensure that the elevator car is stopped in a desirable manner prior to arrival at a predetermined distance from the bottom surface of the elevator shaft. The car buffer assembly includes a stand and buffer to stop the cab, if needed. Unfortunately, the car buffer assembly consumes space in the pit region of the elevator shaft and requires maintenance by a human operator from time to time. It is advantageous to reduce the overall size of elevator shafts, however, the car buffer assembly is an obstacle to achieving such a size reduction.

### BRIEF DESCRIPTION OF THE INVENTION

According to one embodiment, a monitoring system for an elevator system to ensure a predetermined elevator shaft clearance is provided and includes an elevator car moveably disposed in an elevator shaft and guided along at least one guide rail, the elevator shaft having a top surface and a bottom surface. Also included is a counterweight moveably disposed in the elevator shaft. Further included is a position monitoring device monitoring a position of at least one of the elevator car and the counterweight relative to at least one of the top surface and the bottom surface. Yet further included is a braking device actuated to initiate a braking event in response to detection of the position of at least one of the elevator car and the counterweight being within a predetermined distance from one of the top surface and the bottom surface.

In addition to one or more of the features described above, or as an alternative, further embodiments may include that the position monitoring device is operatively coupled to at least one of the elevator car and the counterweight.

In addition to one or more of the features described above, or as an alternative, further embodiments may include that the elevator monitoring system does not include a buffer assembly disposed on the bottom surface of the elevator shaft.

In addition to one or more of the features described above, or as an alternative, further embodiments may include that the braking device comprises a safety gear operatively coupled to at least one of the elevator car and the counterweight and frictionally engageable with the guide rail to fully stop the elevator car at a position that is greater than or equal to the predetermined elevator shaft clearance, the safety gear comprising one of a mechanical and electrical safety gear.

In addition to one or more of the features described above, or as an alternative, further embodiments may include that the elevator car is fully stopped solely by the safety gear.

In addition to one or more of the features described above, or as an alternative, further embodiments may include a plurality of position monitoring device.

In addition to one or more of the features described above, or as an alternative, further embodiments may include a plurality of electrical safety gears operatively coupled to at least one of the elevator car and the counterweight.

In addition to one or more of the features described above, or as an alternative, further embodiments may include that the position monitoring device comprises a processing device disposed therein.

In addition to one or more of the features described above, or as an alternative, further embodiments may include that the position monitoring device is in operative communication with a processing device.

In addition to one or more of the features described above, or as an alternative, further embodiments may include that the braking device comprises a mechanical assembly including a governor and safety block.

In addition to one or more of the features described above, or as an alternative, further embodiments may include that the position monitoring device is operatively coupled to the governor.

According to one embodiment, a monitoring system for an elevator system to ensure a predetermined elevator shaft clearance is provided and includes an elevator car moveably disposed in an elevator shaft and guided along at least one guide rail, the elevator shaft, the elevator shaft having a top surface and a bottom surface. Also included is a primary position monitoring system for monitoring a position of the elevator car relative to at least one of the top surface and the bottom surface. Further included is a secondary position monitoring system for monitoring the position of the elevator car relative to at least one of the top surface and the bottom surface. Yet further included is a braking system for initiating a braking event in response to detection of the position of at least one of the elevator car and a counterweight being within a predetermined distance from one of the top surface and the bottom surface.

In addition to one or more of the features described above, or as an alternative, further embodiments may include that the primary position monitoring system comprises a laser device that generates a laser toward at least one of the top surface and the bottom surface of the elevator shaft.

In addition to one or more of the features described above, or as an alternative, further embodiments may include that the primary position monitoring system comprises a laser device that generates a laser toward at least one of the elevator car and the counterweight.

In addition to one or more of the features described above, or as an alternative, further embodiments may include that the primary position monitoring system comprises an ultrasound device that generates ultrasonic waves.

In addition to one or more of the features described above, or as an alternative, further embodiments may include that the secondary position monitoring system comprises an electrical position detection system configured to detect a position of the elevator car.

In addition to one or more of the features described above, or as an alternative, further embodiments may include that the primary position monitoring system and the secondary position monitoring system are each in communication with a processing device.

In addition to one or more of the features described above, or as an alternative, further embodiments may include that the processing device is in communication with the braking system to initiate the braking event in response to detection of the position of at least one of the elevator car and the counterweight being within the predetermined distance from one of the top surface and the bottom surface.

In addition to one or more of the features described above, or as an alternative, further embodiments may include that the monitoring system does not include a buffer assembly disposed on the bottom surface of the elevator shaft.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a side view of an elevator system and a monitoring system associated therewith, the monitoring system shown according to a first embodiment;

FIG. 2 is a side view of the elevator system and the monitoring system in a first position;

FIG. 3 is a side view of the elevator system and the monitoring system in a second position; and

FIG. 4 is a side, schematic view of the monitoring system according to a second embodiment.

### DETAILED DESCRIPTION OF THE INVENTION

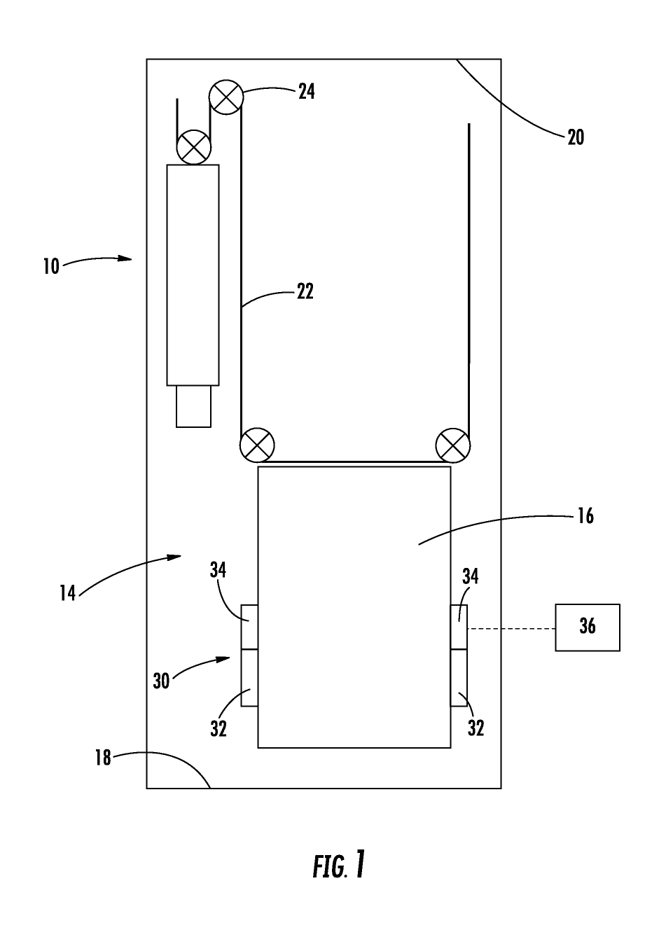

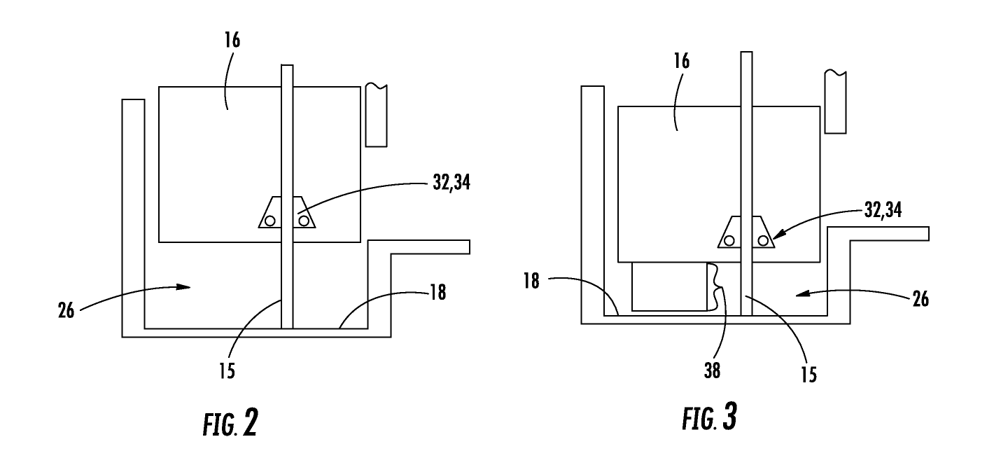

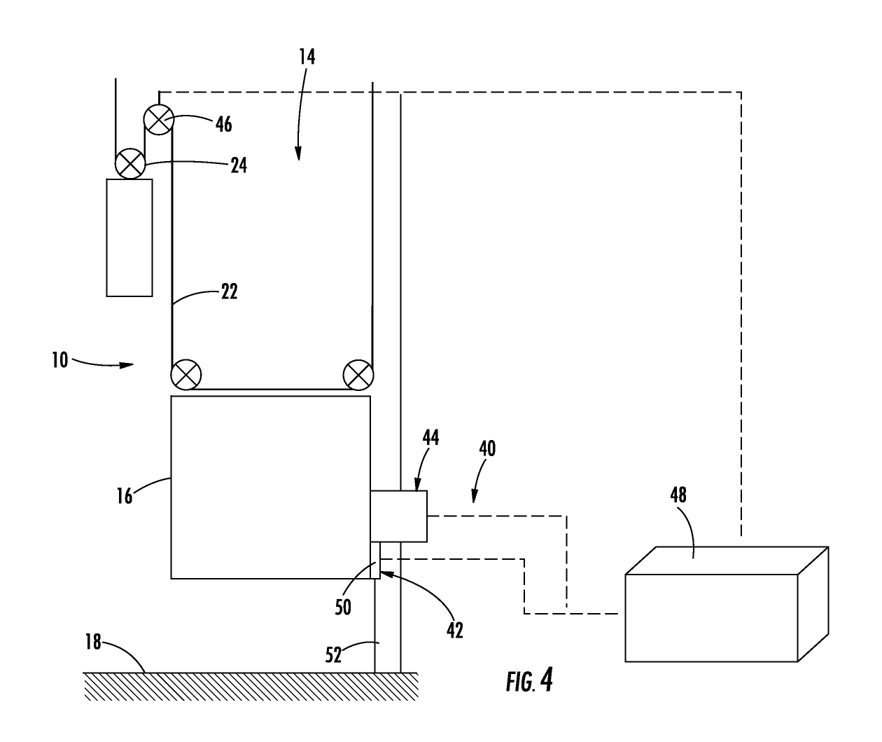

Referring to FIG. 1, an elevator system 10 is illustrated and includes an elevator car 16 that moves along at least one guide rail 15 (FIGS. 2 and 3) of an elevator shaft in a known manner. The elevator car 16 is disposed within an elevator shaft 14 and is moveable therein, typically in a vertical manner. In one embodiment, the elevator car 16 essentially moves along the entire length of the elevator shaft 14 between a bottom surface 18 (i.e., a pit region) and a top surface 20. A drive system (not illustrated) includes a motor and brake and is conventionally used to control the vertical movements of the elevator car 16 along the elevator shaft 14 via a traction system (partially illustrated) that includes cables, belts or the like 22 and at least one pulley 24. It should be readily appreciated as well that, although the elevator assembly 10 is disclosed herein as including a pulley 24, the elevator assembly 10 can be implemented with other drive systems, such as a motor-driven elevator (e.g., a ropeless, self-propelled elevator).

To avoid the possibility of the elevator car 16 moving to a position in the elevator shaft 14 that is within a predetermined distance of the bottom surface 18 and/or the top surface 20 of the elevator shaft 14, a monitoring system is provided to monitor the position of the elevator 16 relative to the bottom and/or top surfaces 18, 20. As will be appreciated from the description herein, the monitoring system facilitates braking of the elevator car 16, if needed, to avoid moving to a position within the aforementioned predetermined distance. FIGS. 2 and 3 depict the elevator car 16 in close proximity with a pit region 26 that is located adjacent the bottom surface 18 of the elevator shaft 14. It is desirable to halt the movement of the elevator car 14 prior to entering what is defined as the pit region 26. The defined space may vary depending upon the particular application and may be subject to regulations. At least one regulation calls for a height of 500 millimeters.

FIGS. 1-3 illustrate a first embodiment of the monitoring system 30. The monitoring system 30 includes an electrical or mechanical safety gear 32 operatively coupled to the elevator car 16 in the form of a stopping or braking device.

It is contemplated that a plurality of safety gears are included. In the case of an electric safety gear 32, the safety gear is part of an overall electric braking system that is operable to assist in braking (e.g., slowing or stopping movement) of the elevator car 16 by frictionally engaging the at least one guide rail 15. The monitoring system 30 also includes an a position monitoring device 34 that monitors various parameters and conditions of the elevator car 16 and to compare the monitored parameters and conditions to at least one predetermined condition. In one embodiment, the position monitoring device 34 is an electrical safety actuation module (and may be referred to as such herein) that is operatively coupled to the elevator car 16 and/or the counterweight and is in close proximity to the electrical safety gear 32 or may be remotely located. Alternatively, the position monitoring device may be coupled to a fixed element in the hoistway, such as a governor in a mechanical assembly. The position monitoring device 34 monitors the position of the elevator car 16 and/or the counterweight. In the event the position is within the predetermined condition (i.e., distance to upper or lower surface of elevator shaft), the electrical safety gear 32 is actuated to facilitate engagement with the guide rail 15. Various triggering mechanisms or components may be employed to actuate the electrical safety gear 32. It is to be appreciated that a plurality of electrical safety actuation modules 34 may be included. It should also be appreciated that in mechanical embodiments, the governor works with a safety block to provide a braking event.

The electrical safety actuation module 34 monitors the position of the elevator car 16. In particular, the electrical safety actuation module 34 monitors the position of the elevator car 16 relative to the bottom surface 18 and/or top surface 20 of the elevator shaft 14. If the electrical safety actuation module 34 detects a position within the predetermined distance of the bottom surface 18 and/or the top surface 20, a braking event (also referred to herein as a “stopping event”) is initiated to cause the electrical safety gear 32 to frictionally engage the guide rail 15. Detection of the predetermined distance may be made in a number of contemplated manners. In one embodiment, the electrical safety actuation module 34 itself is a processing device capable of storing and processing data. In another embodiment, the electrical safety actuation module 34 is in operable communication with a processing device 36 that is capable of storing and processing data. In some embodiments, the processing device 36 comprises a system referred to as programmable electronic systems in safety related applications (PESSRAL).

FIGS. 2 and 3 illustrate the elevator car 16 in two distinct positions within the elevator shaft 14 during operation of the monitoring system 30. In particular, as the elevator car 16 is moving downward within the elevator shaft 14, a first position (FIG. 2) is reached that causes initiation of a braking event by the electrical safety actuation module 34 and by engagement of the electrical safety gear 32 with the guide rail 15. The braking event forces the elevator car 16 to come to a fully stopped position that is shown as the second position of (FIG. 3). The fully stopped position corresponds to a position that leaves a distance between the elevator car 16 and the bottom surface 18 of the elevator shaft 14 that is greater than or equal to a predetermined distance 38.

In one embodiment, the elevator car 16 is stopped solely by the electrical safety gear 32, thereby eliminating the need for the presence of a car buffer assembly that includes a stand and buffer. Therefore, the monitoring and/or braking system, and the elevator system as a whole, does not include a car buffer assembly disposed on the bottom surface of the elevator shaft 14. Such an assembly is often required to ensure stopping of the elevator car 16 under certain conditions. However, by avoiding the presence of a car buffer assembly, the cost of the assembly is decreased and maintenance of the assembly by human personnel is not required. Obviating the need for human personnel in the pit advantageously allows for a smaller pit region and/or overhead region and overall elevator shaft design.

Referring to FIG. 4, a second embodiment of the monitoring system 40 is illustrated. In the illustrated embodiment, a primary position monitoring system 42 and a secondary position monitoring system 44 are included to facilitate a redundancy of the overall monitoring system 40. Both the primary and secondary systems 42, 44 monitor a position of the elevator car 16 relative to the bottom surface 18 and/or the top surface 20 of the elevator shaft 14. A braking system 46 is provided to facilitate braking of the elevator car 16 if the car's position is detected to be within a predetermined distance of the bottom or top surface 18, 20 of the elevator shaft 14. As discussed above in relation to the first embodiment of FIGS. 1-3, once a predetermined distance is detected, a braking event is initiated to fully stop the elevator car 16 at a predetermined distance from the bottom or top surface 18, 20.

The braking system 46 of the illustrated embodiment is shown to be a component or assembly located along the cable of the elevator system, however, it is to be appreciated that the braking system 46 may be the electrical safety gear 32 described in detail above. Irrespective of the precise type of braking system 46, the primary and secondary systems 42, 44 both communicate with a processing device 48 that is capable of storing and processing data. The processing device 48 is also in communication with the braking system 46 to initiate the braking event, if needed.

In one embodiment, the primary position monitoring system 42 comprises a laser device 50 that generates a laser 52 toward one of the bottom or top surfaces 18, 20 of the elevator shaft 14. In the illustrated embodiment, the laser 52 is directed toward the bottom surface 18, but it is to be understood that the same or a different device may direct a laser toward the top surface in some embodiments. Additionally, the laser device 50 may be located at an upper and/or lower surface of the elevator shaft 14, with the laser 52 generated toward the elevator car 16 and/or the counterweight. The laser device 50 communicates a signal to the processing device 48 with data relating to positional information about the elevator car 16 relative to the bottom surface 18. The secondary position monitoring system 44 comprises an electrical position detection system configured to detect a position of the elevator car 16.

Although the embodiment described above reference the primary system 42 as the laser device 50 and the secondary system 44 as the electrical position detection system, it is to be appreciated that the nomenclature may be reversed, such that the laser device 50 is the secondary system and the electrical position detection system is the primary system. Both systems are constantly running in a simultaneous manner, such that the above-noted nomenclature is arbitrary.

As an alternative to the laser 52 that is generated by the laser device 50, it is contemplated that other devices may be employed to assist with position detection of the elevator car 16 and/or counterweight. For example, an ultrasound device may be employed to generate ultrasonic waves within the elevator shaft 14. As with the laser device 50, the ultrasound device may be coupled to the elevator car, the counterweight, the lower surface of the elevator shaft or the upper surface of the elevator shaft.

As with the embodiments of FIGS. 1-3, the elevator car 16 of the monitoring system 40 of FIG. 4 is stopped solely by the braking system 46, thereby eliminating the need for the presence of a car buffer assembly that includes a stand and buffer. Therefore, to reiterate here, the monitoring and/or braking system, and the elevator system as a whole, does not include a car buffer assembly disposed on the bottom surface of the elevator shaft 14. Such an assembly is often required to ensure stopping of the elevator car 16 under certain conditions. However, by avoiding the presence of a car buffer assembly, the cost of the assembly is eliminated and maintenance of the assembly by human personnel is not required. Obviating the need for human personnel in the pit advantageously allows for a smaller pit region and/or overhead region and overall elevator shaft design.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A monitoring system for an elevator system to ensure a predetermined elevator shaft clearance, the monitoring system comprising:
an elevator car moveably disposed in an elevator shaft and guided along at least one guide rail, the elevator shaft having a top surface and a bottom surface;
a counterweight moveably disposed in the elevator shaft;
a position monitoring device monitoring a position of at least one of the elevator car and the counterweight relative to at least one of the top surface and the bottom surface; and
a braking device actuated to initiate a braking event in response to detection of the position of at least one of the elevator car and the counterweight being within a predetermined distance from one of the top surface and the bottom surface.

2. The monitoring system of claim 1, wherein the position monitoring device is operatively coupled to at least one of the elevator car and the counterweight.

3. The monitoring system of claim 1, wherein the elevator monitoring system does not include a buffer assembly disposed on the bottom surface of the elevator shaft.

4. The monitoring system of claim 1, wherein the braking device comprises a safety gear operatively coupled to at least one of the elevator car and the counterweight and frictionally engageable with the guide rail to fully stop the elevator car at a position that is greater than or equal to the predetermined elevator shaft clearance, the safety gear comprising one of a mechanical and electrical safety gear.

5. The monitoring system of claim 4, wherein the elevator car is fully stopped solely by the safety gear.

6. The monitoring system of claim 1, further comprising a plurality of position monitoring device.

7. The monitoring system of claim 1, further comprising a plurality of electrical safety gears operatively coupled to at least one of the elevator car and the counterweight.

8. The monitoring system of claim 1, wherein the position monitoring device comprises a processing device disposed therein.

9. The monitoring system of claim 1, wherein the position monitoring device is in operative communication with a processing device.

10. The monitoring system of claim 1, wherein the braking device comprises a mechanical assembly including a governor and safety block.

11. The monitoring system of claim 10, wherein the position monitoring device is operatively coupled to the governor.

12. A monitoring system for an elevator system to ensure a predetermined elevator shaft clearance, the monitoring system comprising:
an elevator car moveably disposed in an elevator shaft and guided along at least one guide rail, the elevator shaft, the elevator shaft having a top surface and a bottom surface;
a primary position monitoring system for monitoring a position of the elevator car relative to at least one of the top surface and the bottom surface;
a secondary position monitoring system for monitoring the position of the elevator car relative to at least one of the top surface and the bottom surface; and
a braking system for initiating a braking event in response to detection of the position of at least one of the elevator car and a counterweight being within a predetermined distance from one of the top surface and the bottom surface.

13. The monitoring system of claim 12, wherein the primary position monitoring system comprises a laser device that generates a laser toward at least one of the top surface and the bottom surface of the elevator shaft.

14. The monitoring system of claim 12, wherein the primary position monitoring system comprises a laser device that generates a laser toward at least one of the elevator car and the counterweight.

15. The monitoring system of claim 12, wherein the primary position monitoring system comprises an ultrasound device that generates ultrasonic waves.

16. The monitoring system of claim 12, wherein the secondary position monitoring system comprises an electrical position detection system configured to detect a position of the elevator car.

17. The monitoring system of claim 12, wherein the primary position monitoring system and the secondary position monitoring system are each in communication with a processing device.

18. The monitoring system of claim 17, wherein the processing device is in communication with the braking system to initiate the braking event in response to detection of the position of at least one of the elevator car and the counterweight being within the predetermined distance from one of the top surface and the bottom surface.

19. The monitoring system of claim 12, wherein the monitoring system does not include a buffer assembly disposed on the bottom surface of the elevator shaft.
